(19) United States
(12) Patent Application Publication
(10) Pub. No.: US 2008/0158281 A1
(43) Pub. Date: Jul. 3, 2008

(54) IMAGE FORMING APPARATUS AND CONTROL METHOD THEREOF

(75) Inventor: Kazuhiro Saito, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/960,151

(22) Filed: Dec. 19, 2007

(30) Foreign Application Priority Data
Dec. 27, 2006 (JP) 2006-353176

(51) Int. Cl. B41J 2/205

(52) U.S. Cl. 347/15

(57) ABSTRACT

To expand the color reproduction region beyond conventional performance, an image forming apparatus comprises a memory unit storing n mask patterns, a recording pattern generation unit generating n recording patterns, based on the recording color components' image data and the n mask patterns, a classification unit classifying, into at least two groups, based on the recording color components' brightness, the n recording patterns of each, recording color component, an allocation unit allocating the n recording patterns of a recording color component belonging to a low-brightness group, and allocating the n recording patterns of a recording color component belonging to a high-brightness group, and a recording control unit sequentially feeding the recording medium in the sub-scanning direction by 1/m of a width that a single scan motion of the recording array would record.

### BACKGROUND OF THE INVENTION

1. Field of the Invention

The present invention relates to an image forming technology adapted to overlapping recording of a plurality of different inks.

2. Description of the Related Art

An inkjet recording system forms an image by discharging an ink as a liquid droplet from a recording head that is a recording unit, and causing the liquid droplet of ink to impact upon a recording medium. The recording head may have a line or a serial recording scheme. The line system records by employing a recording head that is as wide as a print region, and moving only the recording medium in a sub-scanning direction. The serial system performs a main scan recording that causes a recording head of a shorter width than the line system to discharge the ink, while move scanning a carriage whereupon the recording head is incorporated over the recording medium. The image is formed in order on the recording medium by repeatedly alternating between the recording main scan and a sub-scan that conveys the recording medium in a direction that is orthogonal to the recording main scan in an increment of a prescribed quantity. In such a circumstance, the width of the region that is recorded by a single recording main scan is determined by an array density and a number of a plurality of ink discharge nozzles that configure the recording head. Consequently, carrying out the recording by repeating the recording main scan for the width and the sub-scan that corresponds to the width is a method that finishes the image in a shortest amount of time. In practice, however, a multi-pass recording system is frequently employed in order to derive a higher degree of quality in the image.

The multi-pass recording system executes n recording main scans, where n is greater than or equal to two, over the image region that is capable of being recorded in a single recording main scan. The quantity of the sub-scan that is performed between each recording main scan corresponds to the recording width of a recording element that is incorporated within each block, when the plurality of recording elements that are arrayed on the recording head are divided into n blocks. The image is thus formed in n recording scans by way of the recording element that is incorporated in the n blocks of a given image region.

When dividing the recording elements into the n blocks, the number of recording elements that is incorporated into each respective block is typically the same for each respective block. The number of recording elements per block is not particularly restricted thereto, however. For example, if a total number of recording blocks does not evenly divide n times, it would be permissible to configure the blocks up to n−1 of an arbitrary number of recording elements m, and the nth block of the uneven remainder of the recording elements. It would be permissible to adopt a method such as regulating the recording width in a forward direction, i.e., an odd-numbered scan, and the recording width in a reverse direction, i.e., an even-numbered scan, by repeating in order the arbitrary M recording elements and an arbitrary L recording elements. It would be permissible, for example, to divide a recording head comprising 10 recording heads into three blocks that are configured of two, six, and two recording elements, respectively, such that only a region that is recorded by the two recording elements that are positioned on either edge are subject to a two-pass multi-pass system recording. In such a circumstance, the region that is recorded by the six recording elements that are positioned centrally have the image completed with a single recording scan, potentially allowing for the multi-pass number to be represented by n=1.5.

Hence, the image is completed according to the multi-pass system by a plurality of recording scans for each different block, and thus, not all of the image data that can be recorded in a single recording main scan is recorded. A mask is employed in order to allot an image data to each respective block. The mask is frequently determined independently of an image signal. For example, positioning an AND gate of the mask and the image signal for each respective recording element allows forming a configuration that determines whether or not to record the image signal that is allocated for each respective recording scan.

In such a circumstance, a rate that an individual data is recorded in a single recording main scan is determined by the mask. The image data that is to be recorded in each respective pass is thinned to a certain extent by the mask, and a rate of the thinning will be referred to hereinafter in the present specification as a “thinning rate.” The thinning rate means the reverse of a rate that the recording is performed in each respective recording scan (hereinafter “recording rate”).

Following is a typical concrete example of the multi-pass system that follows the preceding configuration. When employing 100 recording elements to perform a four-pass multi-pass recording the recording elements are divided into four blocks of 25 recording elements each. The sub-scan quantity that is performed between each respective recording scan corresponds to 25 recording elements. The mask that corresponds to each respective block in each respective recording scan is a thinning rate of 75%, meaning a recording rate of 25%. A mask pattern is of a relation wherein the four blocks compensate for one another. The four mask patterns are configured to overlap with one another so as to allow 100% recording. While the present example describes dividing a total of 100 recording elements via a multi-pass number n=4, it is to be understood that the multi-pass recording system is not restricted thereto. It would be permissible for the multi-pass number n not to divide evenly into the number of recording elements. It is possible to enact the multi-pass recording system for a given image region, given a configuration wherein the recording main scan is performed for a plurality of different blocks.

A key reason for employing the multi-pass recording system is to reduce a visibility of a gap that appears in a boundary portion between each respective recording main scan. Additionally, Japanese Patent Laid Open No. 2004-338312 discloses a technology that prevents an inconsistency in glossiness that arises from an ink of an add-on variety when employing the multi-pass recording system. According to the cited reference, color mixing of an ink possessing a wide variation in glossiness according to a quantity of ink that is placed on the recording medium with an ink possessing a small variation in glossiness according to a quantity of ink that is placed on the recording medium controls the mask pattern of the multi-pass recording system. A technique is proposed of controlling the inconsistency in glossiness by discharging the ink possessing the wide variation in glossiness according to the quantity of ink that is placed on the recording medium, followed by discharging the ink possessing the small variation in glossiness according to the quantity of ink that is placed on the recording medium, and fixing the ink upon an upper surface of the sheet of recording material.

Typically, a conventional inkjet recording apparatus applies an ink that is highly osmotic, primarily a dye. Applying the ink that is highly osmotic, such as a dye ink, offers a good color development attribute, owing to a high optical transmittance. When recorded on a glossy print medium, the ink penetrates into the print medium. Thus, a gloss attribute of the medium applies as is, allowing printing with a positive gloss attribute.

An inkjet recording apparatus that applies an add-on ink such as a pigment ink, however, which is suited to a long-term preservation, has a problem such as the following: fixing an ink with a low ink transmittance, i.e., a low brightness, over an ink with a relatively high ink transmittance, i.e., a high brightness, results in a significant reduction in the color development attribute.

### SUMMARY OF THE INVENTION

According to one aspect of the present invention, an image forming apparatus adapted to forming an image by a multi-pass recording, by scan moving a recording medium, in a main scanning direction that is an orthogonal direction to a sub-scanning direction that is a feeding direction of the recording medium, a recording head, comprising a plurality of recording color components of a recording element array that is configured of a plurality of recording elements that are arranged in the sub-scanning direction, and sequentially feeding the recording medium in the sub-scanning direction by a width that is smaller than a width of a band image that may be formed by the recording element array with each successive scan movement of the recording head, the image forming apparatus comprises: a memory unit adapted to storing n mask patterns, where n is an integer greater than 1, wherein the mask patterns are all different from one another, and are employed in a multi-pass recording that is performed n times; a recording pattern generation unit adapted to generating n recording patterns, in accordance with the image data of the recording color components and the n mask patterns that are stored in the memory unit; a classification unit adapted to classifying, into at least two brightness groups, in accordance with a brightness of the recording color components, the n recording patterns of each respective recording color component that are generated by the recording pattern generation unit; an allocation unit adapted to dividing by m the recording element array of each respective recording color component, where m is an integer greater than n, allocating the n recording patterns of a recording color component that belong to a low-brightness group to n array divisions, of the m array divisions, that are recorded in a preceding order on the recording medium, and allocating the n recording patterns of a recording color component that belong to a high-brightness group to n array divisions, of the m array divisions, that are recorded in a succeeding order on the recording medium; and a recording control unit adapted to sequentially feeding the recording medium in the sub-scanning direction by a width of 1/m of a width that may possibly be recorded in a single scan motion of the recording array, when recording by scan moving the recording head according to each respective recording pattern of each respective recording color component that is allocated by the allocation unit.

According to another aspect of the present invention, a control method of an image forming apparatus adapted to forming an image by a multi-pass recording, by scan moving a recording medium, in a main scanning direction that is an orthogonal direction to a sub-scanning direction that is a feeding direction of the recording medium, a recording head, comprising a plurality of recording color components of a recording element array that is configured of a plurality of recording elements that are arranged in the sub-scanning direction, and sequentially feeding the recording medium in the sub-scanning direction by a width that is smaller than a width of a band image that may be formed by the recording element array with each successive scan movement of the recording head, the control method comprises the steps of: reading n mask patterns, where n is an integer greater than 1, wherein the mask patterns are all different from one another, and that are employed in a multi-pass recording that is performed n times, from a memory unit adapted to storing the n mask patterns thereof; generating n recording patterns, in accordance with the image data of the recording color components and the n mask patterns that are stored in the memory unit; classifying, into at least two brightness groups, in accordance with a brightness of the recording color components, the n recording patterns of each respective recording color component that are generated by the recording pattern generation step; dividing by m the recording element array of each respective recording color component, where m is an integer greater than n, allocating the n recording patterns of a recording color component that belong to a low-brightness group to n array divisions, of the m array divisions, that are recorded in a preceding order on the recording medium, and allocating the n recording patterns of a recording color component that belong to a high-brightness group to n array divisions, of the m array divisions, that are recorded in a succeeding order on the recording medium; and sequentially feeding the recording medium in the sub-scanning direction by a width of 1/m of a width that may possibly be recorded in a single scan motion of the recording array, when recording by scan moving the recording head according to each respective recording pattern of each respective recording color component that is allocated in the allocation step.

According to still another aspect of the present invention, an image forming apparatus adapted to discharging an ink of a plurality of colors, incorporating a pigment as a color material, and performing a plurality of recording scans for a given image region of a recording medium, when forming an image on the recording medium, the image forming apparatus comprises: an input unit adapted to inputting a plurality of color component data that represents an image to be formed; a determination unit adapted to determining a combination of an ink that is employed in recording the image to be formed, in accordance with the inputted color component data; and a processing unit adapted to performing a process for setting a rate of dots of the ink that is employed in the recording, for the color component data, with regard to the plurality of recording scans, in accordance with a result of a determination of the determination unit; wherein the processing unit processes the color component data with regard to a final recording scan from among the plurality of recording scans, such that a recording rate of an ink with a relatively high brightness is higher than a recording rate of an ink with a relatively low brightness.

According to yet another aspect of the present invention, a control method of an image forming apparatus adapted to discharging an ink of a plurality of colors, incorporating a pigment as a color material, and performing a plurality of recording scans for a given image region of a recording medium, when forming an image on the recording medium, the method comprises the steps of: inputting a plurality of color component data that represents an image to be formed; determining a combination of an ink that is employed in recording the image to be formed, in accordance with the inputted color component data; and performing a process for setting a rate of dots of the ink that is employed in the recording, for the color component data, with regard to the plurality of recording scans, in accordance with a result of a determination of the determination step; wherein the performing step processes the color component data with regard to a final recording scan from among the plurality of recording scans, such that a recording rate of an ink with a relatively high brightness is higher than a recording rate of an ink with a relatively low brightness.

According to the present invention, it is possible to offer a technology that allows minimizing the degradation in the color attribute that arises when using the ink of the add-on variety, such as the pigment ink, in an overlapping manner.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an oblique external view depicting an overview of a configuration of an inkjet recording apparatus.

FIG. 2 is a block diagram depicting a control configuration of the recording apparatus depicted in FIG. 1.

FIG. 3 is a block diagram depicting a data process when printing an image data via the recording apparatus depicted in FIG. 1.

FIG. 4 depicts an exemplary configuration of a 3-dimensional lattice look-up table.

FIG. 5 depicts an ink configuration with regard to a gray line, from a highlight to a shadow.

FIG. 6 describes an image data scan process that an image scan unit performs.

FIG. 7 is a block diagram describing a configuration of a halftone processing unit.

FIG. 8 is an operation flowchart of the halftone processing unit.

FIG. 9 describes a data that is stored in a cumulative error memory B0007, and a data storage state.

FIG. 10 depicts an exemplary image prior to, and after, the halftone process.

FIG. 11 depicts an internal configuration of the print data.

FIG. 12 depicts an example of a dot position pattern corresponding to each respective tone of a pixel.

FIG. 13 describes a multi-pass recording.

FIG. 14 depicts a recording head configuration.

FIG. 15 depicts an example of a mask pattern that is actually applied by the recording head depicted in FIG. 14.

FIG. 16 is a block diagram depicting a data process when printing an image data via the recording apparatus according to a first embodiment.

FIG. 17 depicts an exemplary mask design that implements a six-way division of a nozzle array of the recording head, and two segmented multi-pass recordings, for four passes in all.

FIG. 18 depicts an exemplary ink fixing order.

FIG. 19 depicts a typical setting of a grouping with regard to a four-color CMYK ink configuration.

FIG. 20 is a grouping process flowchart.

FIG. 21A and FIG. 21B respectively depict an exemplary mask allocation in both a chromatic and an achromatic region.

FIG. 22 depicts an exemplary six-color ink grouping.

FIG. 23 depicts an exemplary eleven-color ink grouping.

FIG. 24A and FIG. 24B depict another example employing the multi-pass system that records a given region in six passes.

FIG. 25 depicts another example employing the multi-pass system that records a given region in six passes.

### DESCRIPTION OF THE EMBODIMENTS

Following is a detailed description of preferred embodiments of the present invention, with reference to the attached drawings. It is to be understood that the configurations of the elements disclosed in the embodiments are exemplary, and that the scope of the claims of the invention is not restricted thereto.

### First Embodiment

Following is a description of an inkjet recording apparatus as an example of a first embodiment of an image forming apparatus according to the present invention. A description of a control method of a recording order that is a core component of the present invention will follow the description of the predicate inject recording apparatus and the control thereof.

For the purposes of the present specification, “record” or “print” does not distinguish between forming significant information, such as text or pictures, or insignificant information. It is also presumed that the term “record” or “print” signifies forming such as a wide range of images, designs, or patterns on a wide range of recording media, as well as performing a modification or a post process of the medium, without regard to whether or not the images, designs, patterns, or other information are revealed so as to be perceivable by human vision. The term “color” includes both color and black-and-white, unless otherwise specified.

The present specification denotes a color, a data, or a hue of a recording agent that is an ink by such names as cyan, magenta, yellow, black, red, green or blue, as well as by their capitalized initials, such as C, M, Y, K, R, G, B, or a combination of the capitalized initials thereof and a lower-case letter.

For the purposes of the present specification, the term “pixel” is the smallest unit that can be tonally rendered, as well as the smallest unit that is subject to an image process of a multi-value data of a plurality of bits, such as a color matching, a color separation, a gamma correction, or a halftone process. The halftone process, to be described hereinafter, corresponds to configuring one pixel of a pattern of 2×4 squares, wherein each square within the pixel is referred to as an “area,” which is the smallest area whereof a dot is defined as on or off.

It is presumed that a pigment-type ink is employed as a color material. In particular, the color medium that is an ink that coagulates on a surface of a recording medium, a tendency whereof the pigment-type ink is strong, has a more significantly visible effect than the color medium that is an ink that penetrates into the recording medium, a tendency whereof the dye-type ink is strong. When a recording is performed on a given region of the recording medium using a plurality of inks, the pigment-type ink possesses an attribute of being an add-on type ink that fixes the later ink recording on an upper layer, i.e., a surface, of the earlier ink recording.

Related Art

### Description of the Inkjet Recording Apparatus Apparatus Configuration

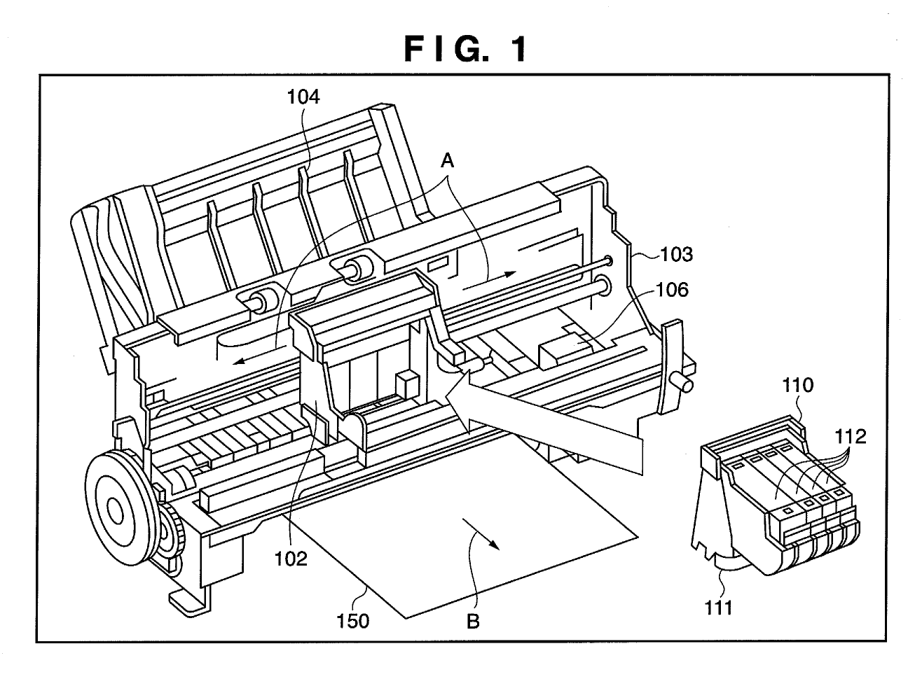

FIG. 1 is an oblique external view depicting an overview of a configuration of an inkjet recording apparatus.

As depicted in FIG. 1, the inkjet recording apparatus (hereinafter “recording apparatus” or “printer”) transits a carriage 102 in a forward and a reverse direction of an arrow A. The transit is carried out by transmitting a drive power that is generated by a carriage motor M1, via a transmission mechanism, to an inkjet cartridge 110, that is contained in a recording head 111 that performs a recording by discharging the ink according to the inkjet system. The recording is performed by, for example, a recording medium 150, such as a sheet of recording paper, feeding via a print paper feed mechanism 104, which conveys the recording medium 150 to a recording position, and discharging the ink at the recording position from the recording head 111 to the recording medium.

In order to maintain the recording head 111 in good condition, the carriage 102 is transited to a position of a recovery apparatus 106, whereat a discharge recovery process of the recording head 111 is performed intermittently.

An ink tank 112, which contains the ink that is supplied to the recording head 111, is mounted in the inkjet cartridge 110 of the recording apparatus 100. The ink tank 112 may be freely fitted into, and removed from, the inkjet cartridge 110.

The recording apparatus 100 that is depicted in FIG. 1 is capable of color recording. Consequently, the ink tank 110 contains four ink tanks, one for each of magenta (M), cyan (C), yellow (Y), and black (K) ink. Each of the four ink tanks may be mounted and removed independently of the others.

The carriage 102 and the ink cartridge 110 are capable of achieving and maintaining a needed electrical connection by bringing a bonding interface of the respective components into contact in an appropriate manner. By applying an energy according to a recording signal, the recording head 111 records, selectively discharging the ink from a plurality of nozzles. The recording head 111 according to the embodiment employs the inkjet system that uses a thermal energy to discharge the ink, and comprises an electrothermal transducer to generate the thermal energy. An electrical energy that is applied to the electrothermal transducer is converted to the thermal energy. A bubble is caused to grow and shrink by a film boiling that results from the application of the thermal energy to the ink, and the growing and shrinkage of the bubble causes a pressure change in the ink. The ink is discharged via the nozzle by using the pressure change. The electrothermal transducer, which is installed to correspond to each respective nozzle, discharges the ink from the corresponding nozzle by applying a pulse voltage to the electrothermal transducer, in response to the recording signal.

Per the depiction in FIG. 1, the carriage 102 is linked to a portion of a drive belt of the transmission mechanism that transmits the drive power of the carriage motor M1, and is guided and maintained to move freely in the direction of the arrow A, as per a guide shift. Accordingly, the carriage 102 scans back and forth as per the guide shift, in accordance with a forward and a reverse operation of the carriage motor M1. A scale is comprised that denotes an absolute position of the carriage 102 as per the transit direction, i.e., the direction of the arrow A, of the carriage 102. According to the embodiment, the scale employs a printing of a black bar on a transparent PET film at a necessary pitch, with one end thereof attached to a chassis 103, and another end supported by a spring (not shown).

The recording apparatus 100 incorporates a platen (not shown) in opposition to a nozzle interface that is formed by the nozzle (not shown) of the recording head 111. The drive power of the carriage motor M1 causes the ink cartridge 110 that is mounted in the recording head 111 to scan back and forth. Simultaneously, the recording is performed across a full width of the recording medium 150 that is conveyed upon the platen by applying the recording signal to the recording head 111 and discharging the ink.

FIG. 1 also depicts a conveyor roller for conveying the recording medium 150, that is driven by a conveyor motor M2. Depicted therein are a pinch roller that holds the recording medium 150 to the conveyor roller by a spring (not shown), a pinch roller holder that maintains the pinch roller in a manner that allows the pinch roller to rotate freely, and a conveyor roller gear that is attached to an end of the conveyor roller. A rotation of the conveyor motor M2 that is transmitted to the conveyor roller gear via an intermediate gear (not shown) drives the conveyor roller.

An output roller is also present, which outputs the recording medium 150, whereupon the image is formed by the recording head 111, externally to the recording apparatus. The output roller is driven by transmitting the rotation of the conveyor motor M2 thereto. The output roller is held to the recording medium 150 by a spur roller (not shown) that presses on a spring (not shown). A spur holder is present that maintains the spur roller in manner that allows the spur roller to rotate freely.

Per the depiction in FIG. 1, a recovery apparatus 106 is installed in the recording apparatus 100. Located outside a range of the back and forth movement for a recording operation, i.e., outside of a recording region, of the ink cartridge 110 that is mounted in the recording head 111, the recovery apparatus 106 is located in a prescribed location, for example, a position corresponding to a home position of the recording head 111, where it recovers an ink discharge malfunction of the recording head 111.

The recovery apparatus 106 comprises a capping mechanism, which caps the nozzle interface of the recording head 111, and a wiping mechanism, which cleans the nozzle interface of the recording head 111. A suction unit, such as a suction pump, within the recovery apparatus 106 and linked to the capping mechanism capping the nozzle interface, forcibly causes the ink to be ejected from the nozzle. The recovery apparatus 106 thus performs such a nozzle recovery process as removing such as the ink or the bubble that has caused an increase in a stickiness of an ink channel of the recording head 111.

Capping the nozzle interface of the recording head 111 with the capping mechanism during such a time as when not in the recording operation protects the recording head 111 and allows preventing the ink from evaporating or drying out. The wiping mechanism is placed close to the capping mechanism, where it wipes the ink droplet that adheres to the nozzle interface of the recording head 111.

The capping mechanism and the wiping mechanism allow maintaining the recording head 111 in a proper ink discharge state.

Inkjet Recording Apparatus Control

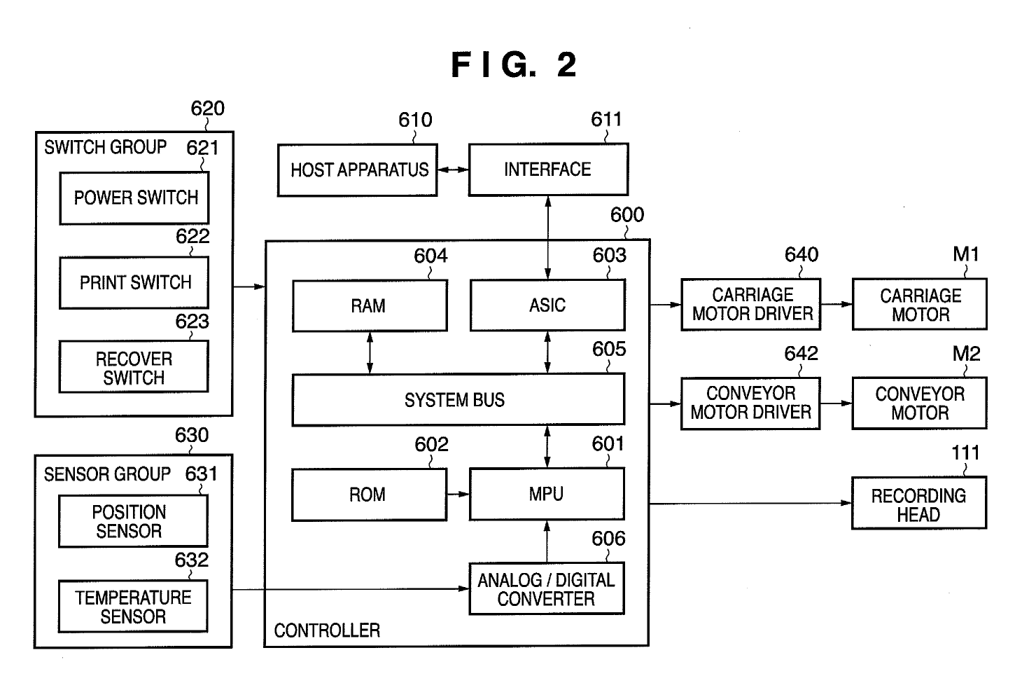

FIG. 2 is a block diagram depicting a control configuration of the recording apparatus depicted in FIG. 1.

Per the depiction in FIG. 2, a controller 600 comprises an MPU 601 and a ROM 602, which stores a program that responds to a control sequence to be described hereinafter, a necessary table, and other fixed data. The controller 600 also comprises an application specific integrated circuit, or ASIC, 603, which generates a control signal for controlling the carriage motor M1, the conveyor motor M2, and the recording head 111. The controller 600 also comprises a RAM 604, which installs such as an image data rendering space or a workspace for executing a program, and a system bus 605, which bidirectionally connects the MPU 601, the ASIC 603, and the RAM 604, and performs a data reception therebetween. The controller 600 is also configured of such as an A/D converter 606, which receives an input of an analog signal from a group of sensors to be described hereinafter, converts the analog signal thus received to a digital signal, and supplies the converted digital signal to the MPU 601.

In FIG. 2, reference numeral 610 is a computer, or such as an image scanning reader or a digital camera, that serves as a supply source of the image data, and is generically referred to as a host apparatus. The host apparatus 610 and the recording apparatus 100 send and receive such as the image data, a command, or a status signal, via an interface 611 therebetween.

Reference numeral 620 is a switch group, comprising a power switch 621 and a print switch 622, which commands a print job to commence. The switch group 620 is also configured of a switch for receiving a command that is inputted by a user, such as a recover switch 623 that commands an activation of a process for maintaining an ink discharge performance of the recording head 111 in a good condition, i.e., the recovery process. Reference numeral 630 is a sensor group, for detecting an apparatus status, which is configured of such as a position sensor 631, such as a photo-coupler, for detection a home position h, and a temperature sensor 632, which is installed in a suitable location of the recording apparatus in order to detect an environmental temperature.

Reference numeral 640 is a carriage motor driver, which drives the carriage motor M1 in order to cause the carriage 102 to scan reciprocally in the direction of the arrow A, and reference numeral 632, reference numeral 642 is a conveyor motor driver, which drives the conveyor motor M2 in order to convey a recording medium P.

During the recording scan by the recording head 111, the ASIC 603 directly accesses a memory region of the RAM 604 and transfers a drive data (DATA) of the recording element, i.e., a discharge heater, to the recording head.

While the configuration depicted in FIG. 1 is capable of separating the ink cartridge 112 and the recording head 111, it would be permissible to configure a head cartridge that is formed thereof in a single unit, and is thus replaceable as a single unit.

Image Data Print Process

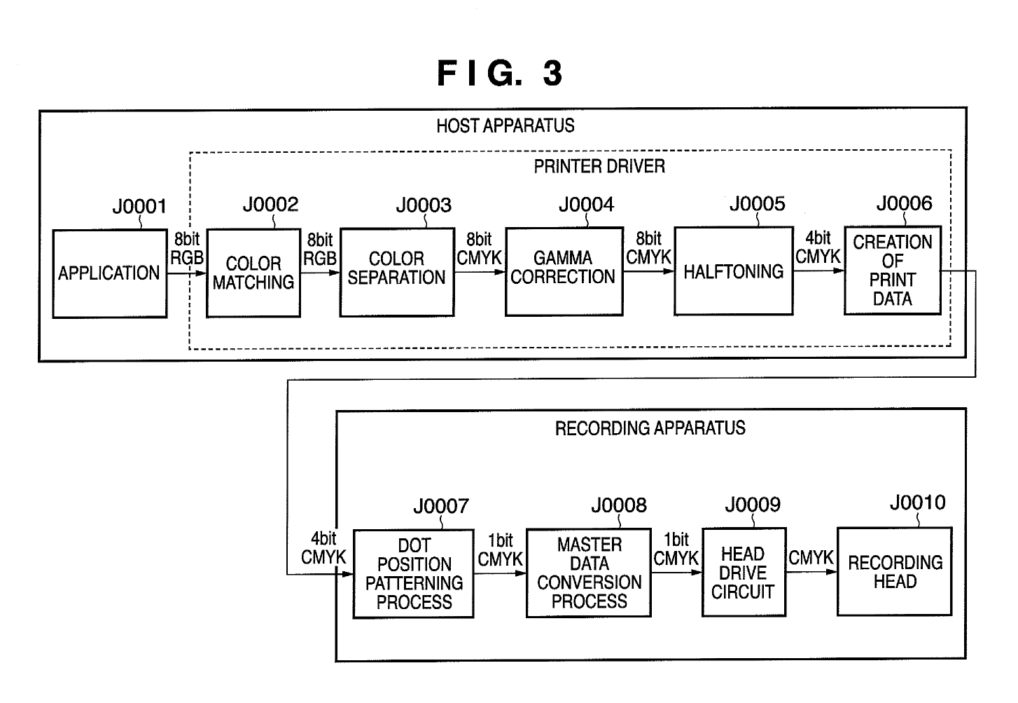

FIG. 3 is a block diagram depicting a data process when printing an image data via the recording apparatus depicted in FIG. 1.

The host apparatus is configured of a personal computer (PC), for example, and an application and a printer driver are present as a program that runs on an operating system.

An application J0001 executes a process that generates the image that will be printed on the printer. It is possible to load the image data or a data prior to an editing or other operation onto the PC via a variety of media. It is possible to load, for example, the image data in a JPEG format that is captured with the digital camera into the host apparatus via a CF card. It would be possible to load the image data in a TIFF format that is extracted by a scanner, or the image data that is stored on a CD-ROM. It would be possible to load the image data via the Internet. The image data that is thus loaded is displayed on a monitor of the PC and subjected to such as the editing or process via the application J0001, and an RGB color image data is created, for example. The color image data is then passed to the printer driver in accordance with the print command from the user, in the RGB data format, comprising eight bits each of red, green, and blue.

The printer driver comprises a color matching process J0002, a color separation process J0003, a gamma correction J0004, a halftoning process J0005, and a print data creation J0006.

The color matching process J0002 performs a mapping of a color region, or a gamut. For example, the color matching process J0002 employs a three-dimensional look-up table, which maps the gamut that is reproduced by the sRGB image data within the gamut that is reproduced by the printer of the print system, and an interpolation computation, to perform a data conversion, or a mapping. The inputted image data in the RGB data format, comprising eight bits each of red, green, and blue, is mapped to an image data in the RGB data format, comprising eight bits each of red, green, and blue, within the gamut of the printer.

The color separation process J0003 generates a color separation data corresponding to a combination of the ink that reproduces the color that data represents, in accordance with the RGB image data whereupon the mapping to the gamut has been performed. In the present circumstance, a data is generated that represents each element of the CMYK. The process is performed by combining both the 3-dimensional look-up table with the interpolation computation, in a manner similar to the color matching process. The output thereof would be, for example, a value of eight bits of each color, corresponding to the C, M, Y, and K color quantity.

The gamma correction J0004 performs a tone value conversion on the data of each color of the color separation data that is derived by the color separation process J0003. The conversion is performed by employing a one-dimensional look-up table that corresponds to a tone attribute of each color of ink of the printer, such that the color separation data is associated with the tone attribute of the printer in a linear fashion. The halftoning process J0005 performs a quantization that converts each of the C, M, Y, and K eight-bit color separation data into a four-bit data. An error diffusion method is employed to convert the eight-bit data for each respective color into the four-bit data.

The four-bit data is a data that becomes an index for denoting a position pattern with regard to a dot position patterning process for the recording apparatus (to be described hereinafter). Finally, the print data creation process J0006 creates a print data that adds a print control information to a print image data, a content of the latter being the four-bit index data.

The process of the application and the printer driver are implemented by having the CPU execute the program. In such a circumstance, the program is employed by being loaded from either the ROM or the hard drive, and by the RAM being employed as the workspace with regard to the execution of the process thereof.

The recording apparatus executes the dot position patterning process J0007 and a mask data conversion process J0008, with regard to processing the image data for printing.

The dot position patterning process J0007 performs a dot position on the inputted image data on a per pixel basis, according to a dot position pattern corresponding to the four-bit index data, i.e., the tone value information. Allocating the dot position pattern corresponding to the tone value of the pixel for each respective pixel that is represented in the four-bit image data defines the on/off setting for each respective dot of the plurality of areas within the pixel, and positions a discharge data of 1 or 0 for each respective area within the pixel. The one-bit discharge data that is thus obtained employs one bit for selecting a pass mask, which is either of two types of mask patterns. The mask pattern thus selected is used to perform a mask process according to a mask data conversion process J0008. The nozzle data of each respective scan for completing the recording of the scan region of a prescribed width by the recording head is generated by the process that employs the mask that corresponds to each respective scan.

The nozzle data C, M, Y, and K of each scan is sent to a drive circuit J0009 at a suitable timing, whereby a recording head J0001 is driven, and each respective ink discharged, according to the discharge data.

The dot position patterning process or the mask data conversion process typically is executed by employing a dedicated hardware, under the control of the CPU that configures the control unit of the recording apparatus. It would be permissible, however, for the process to be performed by having the CPU of the recording apparatus execute the control software. A configuration whereby the process is implemented, in whole or in part, by, for example, the printer driver of the host computer (PC), would also be permissible.

Following is a description in further detail of each respective process.

The Color Matching Process J0002

The color matching process matches the color that is represented on the monitor with the color that is reproduced on the printer. The process performs a color space compression from a monitor gamut that is defined in a color space such as CIE-L*a*b* to a printer gamut. A color space compression technique known as “Perceptual” is a color match that places priority on perceptual matching. Other techniques include “Colorimetric,” which places priority on a calorimetric match, and “Saturation,” which places priority on a saturation match.

The Color Separation Process J0003

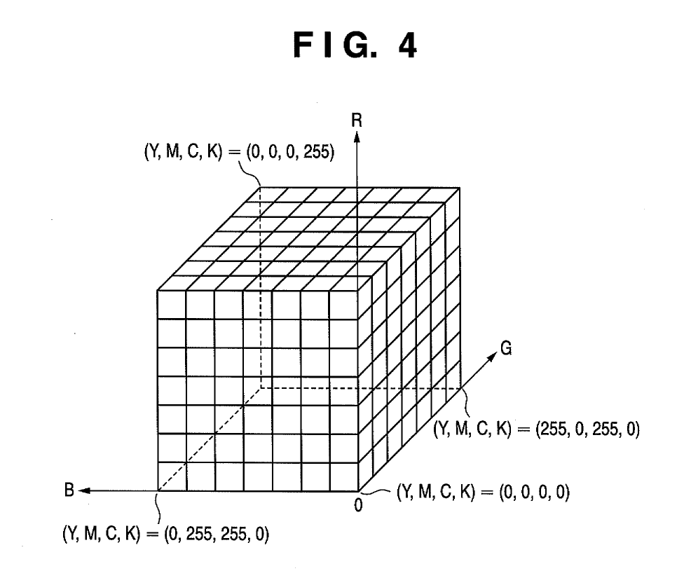

The color separation process convert the inputted RGB data into a color material quantity that corresponds to the CMYK ink color that is the recording material of the printer. In the actual process, the CMYK value that corresponds to the inputted RGB value is stored in a 3-dimensional lattice look-up table such as is depicted in FIG. 4. When an interstitial data is inputted, the calculation is made by a three-dimensional interpolation computation process, such as a tetrahedral interpolation process or a cubical interpolation process. For example, a Y-M hue is a mixture of the Y ink and the M ink, an M-C hue is a mixture of the M ink and the C ink, and a C-Y hue is a mixture of the C ink and the Y ink.

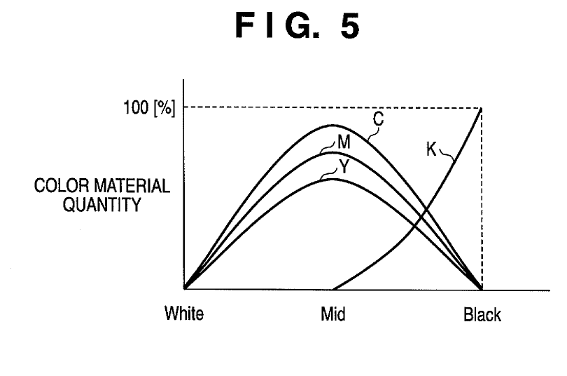

FIG. 5 depicts an ink configuration with regard to a gray line, from a highlight to a shadow. A portion from an intermediate brightness to the highlight is a mixture of the C ink, the M ink, and the Y ink, and a portion from the intermediate brightness to the shadow is a mixture of the C ink, the M ink, the Y ink, and the K ink.

Halftoning (J0005)

Halftoning is configured of an image scan unit and a halftone processing unit.

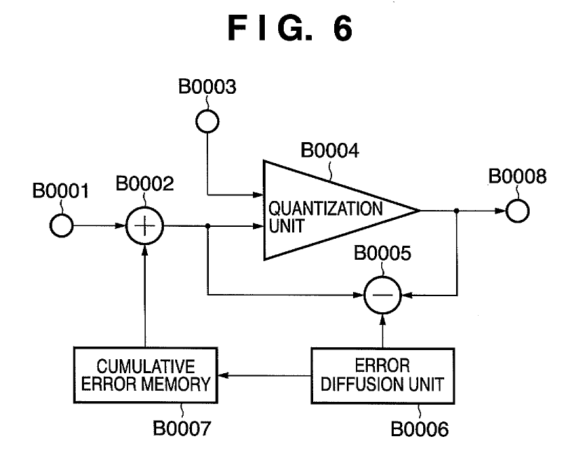

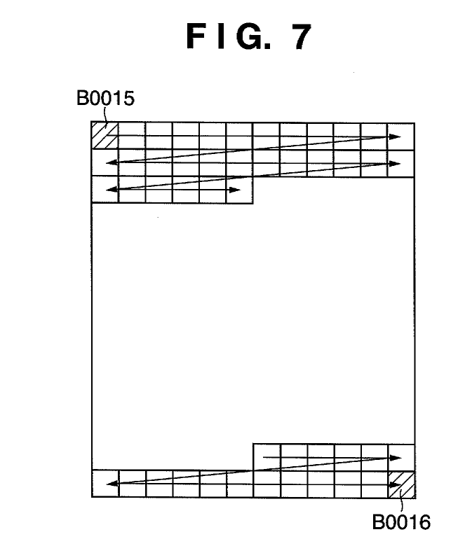

FIG. 6 describes an image data scan process that the image scan unit performs, and FIG. 7 is a block diagram describing a configuration of the halftone processing unit.

Reference numeral B0001 is an input terminal of the pixel data, reference numeral B0002 is a cumulative error addition unit, and reference numeral B0003 is a terminal that sets a quantization threshold when converting the inputted pixel data into two or more tone numbers. Reference numeral B0004 is a quantization unit, reference numeral B0005 is an error computation unit that computes a quantization error, reference numeral B0006 is an error diffusion unit that diffuses the quantization error, reference numeral B0007 is a cumulative error memory that stores the cumulative error, and reference numeral B0008 is an output terminal of the pixel data that is formed after the processing sequence.

The image scan unit selects one pixel at a time whereupon to perform the process from the image data that is configured of an arrangement of a plurality of pixels, and inputs the pixel data into an input terminal B0001 of the halftone processing unit. The pixel data of the pixel that the image scan unit selects from the total image is inputted in order into the input terminal B0001. The halftone processing unit comprises a configuration that performs a process in sequence on each respective pixel data thus inputted, and outputs the processed pixels one at a time via the output terminal B0008.

In FIG. 7, each space denotes each individual pixel. The scan process commences by treating an upper left-hand pixel B0015 of the image region as the selected pixel (hereinafter also referred to as “pixel of interest”). The process proceeds by switching the pixel of interest one pixel at a time to the right, in the direction of the arrow in FIG. 7. When the process is completed, at the rightmost point of the uppermost row, the process moves to the leftmost pixel of the row of pixels one row below the row whereof the process has been completed. The process scan advances via the arrow in FIG. 7 in such a sequence. When the process reaches a lower right-hand pixel B0016, the last pixel in the image, the process scan of the image is completed.

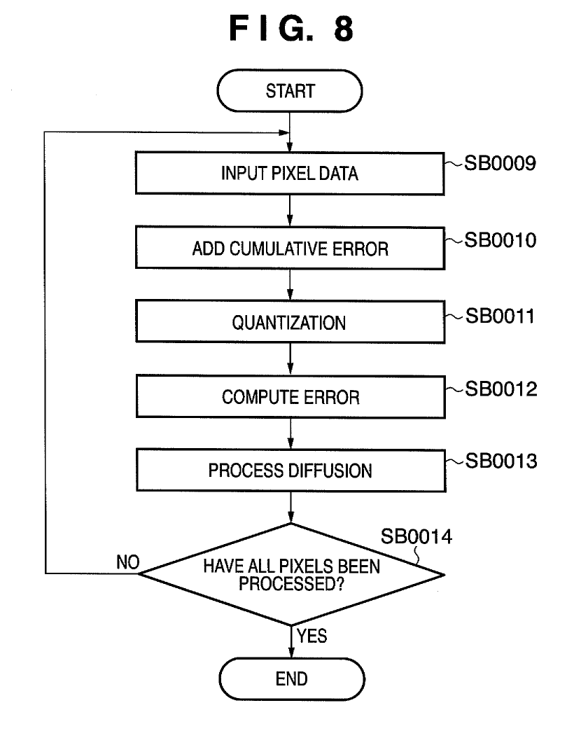

FIG. 8 is an operation flowchart of the halftone processing unit. While the process is executed on a per ink color basis, the following description will concentrate on a single color.

In step SB0009, the pixel data to be processed is inputted by the image scan unit.

In step SB0010, the cumulative error value corresponding to the pixel position, which is stored in the cumulative error memory B0007, is added, in the cumulative error addition unit B0002, to the pixel data thus inputted.

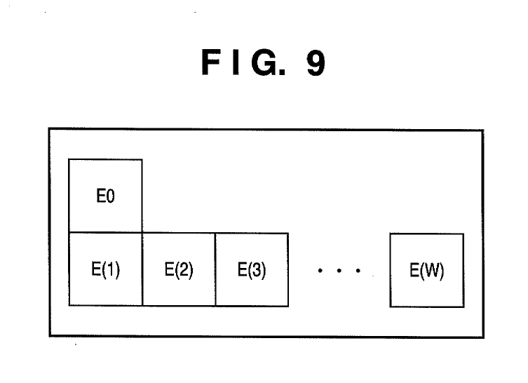

FIG. 9 describes a data that is stored in the cumulative error memory B0007, and a data storage state. A memory region E0 and a number W of memory regions E(x), where x is an integer from 1 to W, are positioned in the cumulative error memory B0007. In the present circumstance, W represents a number of pixels in a horizontal direction of the image data that is to be processed. Each region stores a quantization error E(x) that is applied to the pixel of interest. The value of the quantization error is obtained by a method to be described hereinafter. When the process commences, all regions are initialized to 0.

In the present step, the cumulative error addition unit B0002 adds, to the inputted pixel data, the value of the error memory E(x) corresponding to a position x, where 0<x≦W in the horizontal direction of the pixel. Treating the pixel data that is inputted into the input terminal B0001 as I, and the pixel data after the addition of the cumulative error in step B0010 as I′, gives:

I′=I+E(x)

In step SB0011, the pixel data after the addition of the cumulative error I′ is compared with the threshold that is inputted via the threshold setting terminal B0003, and a quantization process performed. In the present circumstance, the post-quantization image data is sorted into nine stages by comparing eight thresholds with the pixel data after the addition of the cumulative error I′, and the value of the outputted pixel data that is sent to the output terminal B0008 determined. If the value of the pixel data that is inputted via the cumulative error addition unit B0002 is a range of integers from 0 to 255, an output tone value O is determined by the following formulae:

O=0(I′<16) (1)

O=32(16≦I′<48) (2)

O=64(48≦I′<80) (3)

O=96(80≦I′<112) (4)

O=128(112≦I′144) (5)

O=160(144≦I′<176) (6)

O=192(176≦I′208) (7)

O=224(208≦I′<240) (8)

O=255(I′≧240) (9)

For purposes of the present description, the output tone values O will be allocated names as follows: O=0 is Level 0, O=32 is Level 1, O=64 is Level 2, O=96 is Level 3, O=128 is Level 4, O=160 is Level 5, O=192 is Level 6, O=224 is Level 7, and O=255 is Level 8.

In step SB0012, a difference between the pixel data after the addition of the cumulative error I′ and the output pixel value O, i.e., the quantization error E, is computed via the error computation unit B0005:

E=I′−O (10)

In step SB0013, the error diffusion unit B0006 performs an error diffusion process corresponding to the position x of the pixel of interest in the horizontal direction. The quantization error to be stored in the memory region E0 and E(x) is computed according to the following formulae, and stored in the cumulative error memory:

E(x+1)<−−−E(x+1)+E* 7/16(x<W) (11)

E(x−1)<−−−E(x−1)+E* 3/16(x>1) (12)

E(x)<−−−E0+E* 5/16(1≦x≦W) (13)

E(x)<−−−E0+E* 8/16(x=1) (14)

E(x)<−−−E0+E* 13/16(x−W) (15)

E0<−−−E* 1/16(x<W) (16)

E0<−−−0(x=W) (17)

The error diffusion process per pixel that is inputted into the input terminal B0001 is thus completed.

In step SB0014, a determination is made as to whether or not each respective process from step SB0009 through SB0013 have been carried out for all pixels contained in the image data. A determination is made as to whether or not the pixel that the image scan unit selects has reached FIG. 7, reference numeral B0016. If reference numeral B0016 has not been reached, the selection advances by one pixel in the direction of the arrow, and the process proceeds to step SB0009. If it is determined that the process has been performed for all pixels, the halftone process terminates.

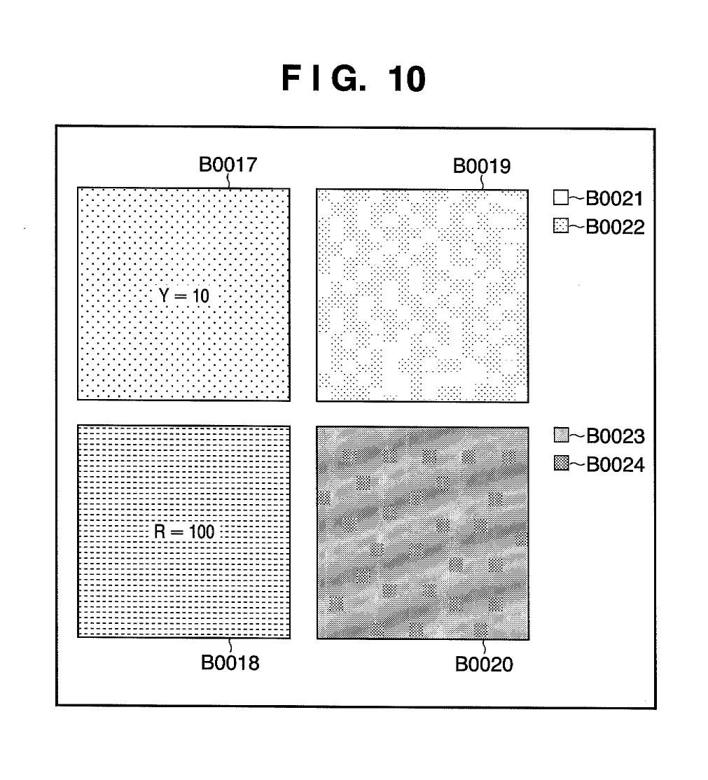

FIG. 10 depicts an exemplary image prior to, and after, the halftone process. The illustration denotes an image data B0017, which is created for yellow (Y), and reference numeral B0019 denotes a result of performing the halftone process thereupon. The illustration denotes an image data B0018, which is created for a red (R) spot color ink, and reference numeral B0020 denotes a result of performing the halftone process thereupon.

The image data B0017 has a pixel value of 10 for all pixels therein. The post-halftone process image B0019 has two levels, or intensities, that are distributed uniformly, of pixels: the O=0, or Level 0, B0021, and the O=32, or Level 1, B0022. The image data B0018 has a pixel value of 100 for all pixels therein. The post-halftone process image 80020 has two levels, or intensities, that are distributed uniformly, of pixels: the O=96, or Level 4, B0023, and the O=128, or Level 5, B0024. In either case, the value of the pixel data that had been the same across all pixels is diffused through pixels of a plurality of levels after the halftone process. The resulting configuration, however, preserves the value of the inputted data when taken across the picture as a whole.

The Print Data Creation J0006

Performing a process described hereinafter that appends the print control information to post-halftone process image data generates the print data.

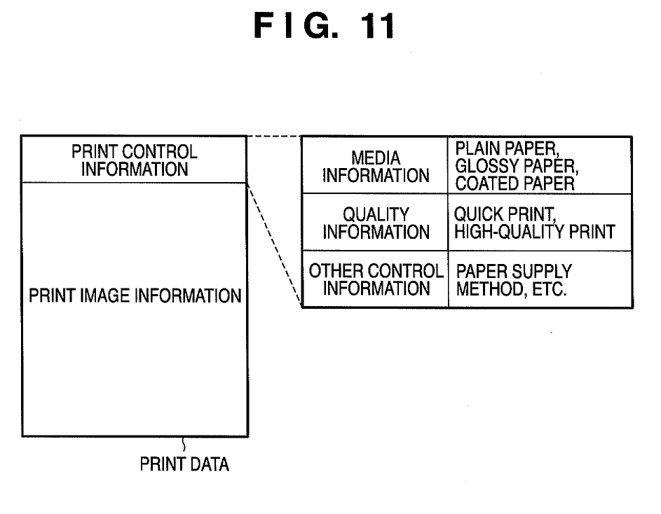

FIG. 11 depicts an internal configuration of the print data. In general, the print data is configured of the print control information that exercises the control over the print, and the print image information (also referred to as “print image data”). The print control information is configured of a media information that records the image, a quality information of the print, and other control information such as a print media supply method.

In the present circumstance, the media information denotes a type of the printing media whereupon the image is to be printed, with one type of the printing medium being defined from among such as a plain paper, a glossy paper, or a coated paper. The quality information denotes a quality of the print, and defines either a quick or a high-quality print. The print control information is formed on the host PC in accordance with the content that the user specifies. The print image information, or the print image data, denotes that the image data has been generated via the halftone process.

The processes J0001 through J0006 are described as being processed by the printer driver that is installed on the host apparatus. A configuration would be permissible, however, that performs the process, in whole or in part, on the recording apparatus.

The Dot Position Patterning Process

The halftone process reduces the 256-value multi-value density information, i.e., the eight-bit data, to the nine-value tone value information, i.e., the four-bit data. It is the two values as to whether or not to record the ink, however, that the inkjet recording apparatus may actually record on the recording medium. Accordingly, the dot position patterning process performs a task of reducing the multiple value levels 0-8 to the two values that determine whether or not the dot is present. The dot position patterning process J0007 allocates the dot position pattern, corresponding to the tone value, i.e., Level 0 through 8, to each pixel that is rendered with the four-bit Level 0 through 8 data that is outputted by the halftone processing unit. The dot on/off is thus defined for each of the plurality of areas within the given pixel, and the one-bit discharge data, either a 1 or a 0, is positioned within each respective area of the pixel.

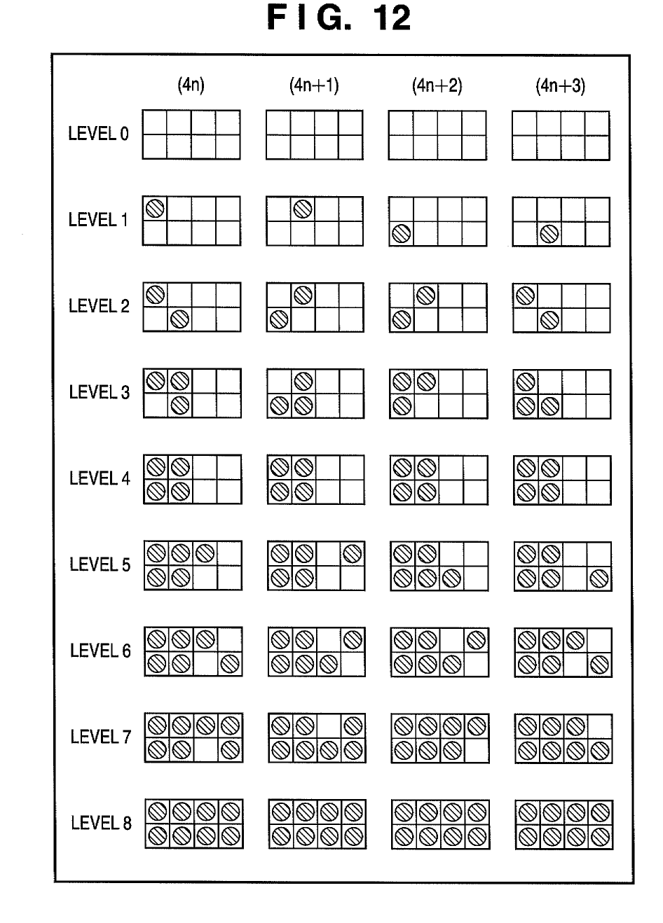

FIG. 12 depicts an example of the dot position pattern corresponding to each respective tone of the pixel. Each respective level value, which is denoted at a left-hand side of FIG. 12 corresponds to the Level 0 through Level 8 that is the outputted value of the halftone processing unit. Each matrix region that is arrayed at a right-hand side thereof, which is configured of two vertical areas by four horizontal areas, corresponds to the one-pixel region that is outputted by the halftone process. Each area within the pixel corresponds to the smallest unit that is defined as the ink dot on/off. An area wherein a circle is entered denotes an area wherein the dot recording is performed, with the number of dots recorded increments by one as the level number increases.

A notation (4n) through (4n+3) that corresponds to a horizontal axis of the illustration denotes the pixel position of the horizontal direction from the left-hand edge of the inputted image by substituting the variable n with an integer greater than zero. Each respective pattern depicted thereunder denotes that a plurality of different patterns are mutually prepared depending on the pixel position, even for a single given input level. The configuration is such that, even if the same level is inputted, the four dot position patterns denoted by (4n) through (4n+3) are allocated in rotation upon the recording medium.

The vertical direction of each dot position pattern denoted in FIG. 12 is treated as the direction of the arrangement of the nozzles of the recording head, and the horizontal direction thereof as the scan direction of the recording head. Configuring such that a variety of dot arrays may be recorded even for a single given level allows obtaining an effect of distributing the number of discharges between a nozzle that is positioned on an upper layer of the dot position pattern and a nozzle that is positioned on a lower layer thereof, and diffusing a wide range of noise that is a characteristic of the recording apparatus.

The Mask Data Conversion Process

The dot position patterning process determines whether or not the dot is present in each respective area of the recording medium. Consequently, inputting the information as is into the drive circuit of the recording head allows recording the desired image. The inkjet recording apparatus, however, primarily adopts the multi-pass recording method for greater image quality. Following is a concise description of the multi-pass recording method.

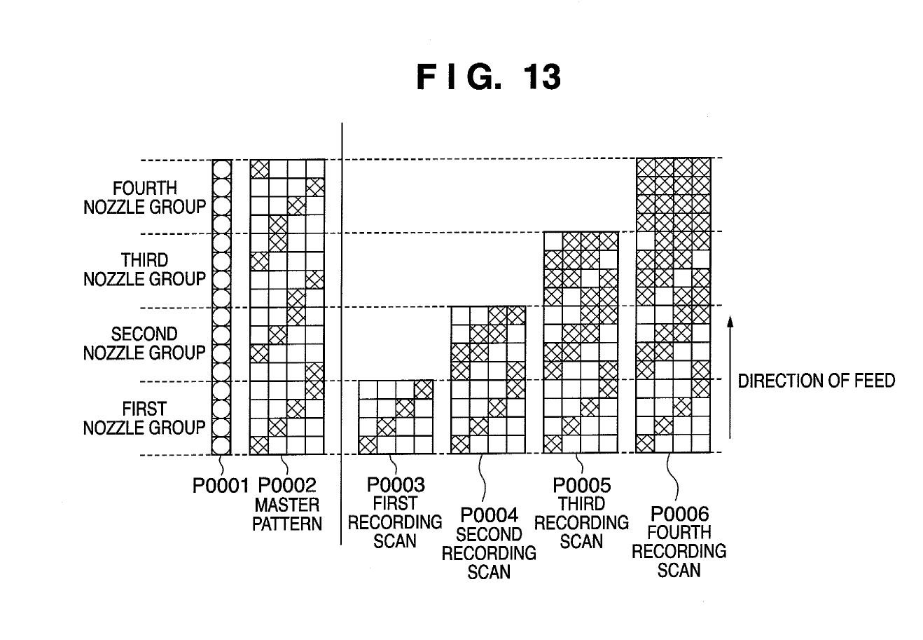

FIG. 13 describes the multi-pass recording. While the following process is performed on a per ink color basis, the description hereinafter focuses on a single color.

Reference numeral P0001 depicts the recording head, which is treated in the present circumstance as comprising 16 nozzles, for purposes of simplicity. Per the illustration, the nozzle array is logically divided into four nozzle groups, numbered 1 through 4, of four nozzles each, with each nozzle group containing four nozzles. Reference numeral P0002 denotes the mask pattern, with a recordable area for each nozzle being denoted by a black fill. The mask pattern that corresponds to each respective nozzle group are in a mutually complementary relationship, with a configuration such that overlapping the mask pattern completes the recording of the region that corresponds to the 4×4 area.

The patterns denoted by reference numerals P0003 through P0006 denote an example of a situation wherein the image is completed by overlapping the recording scan. As each respective recording scan terminates, the recording medium is conveyed by the conveyor roller in the direction of the arrow in the illustration that is equivalent to the width of the nozzle group, i.e., the width of four nozzles. The resulting configuration completes the forming of the image of the region upon the recording medium when the four recording scans are completed. Forming the image on the region of the recording medium via the plurality of scans of the plurality of nozzle groups has an effect of reducing such as a discrepancy that is a characteristic of the nozzle or a discrepancy in a precision in the conveyance of the recording medium.

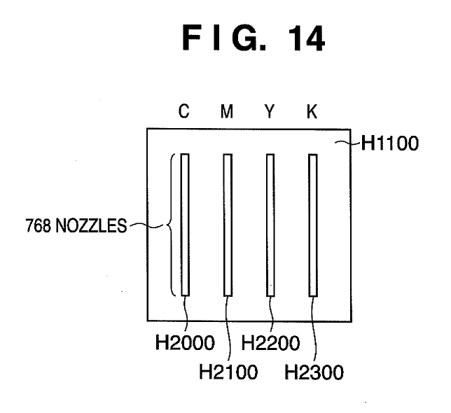

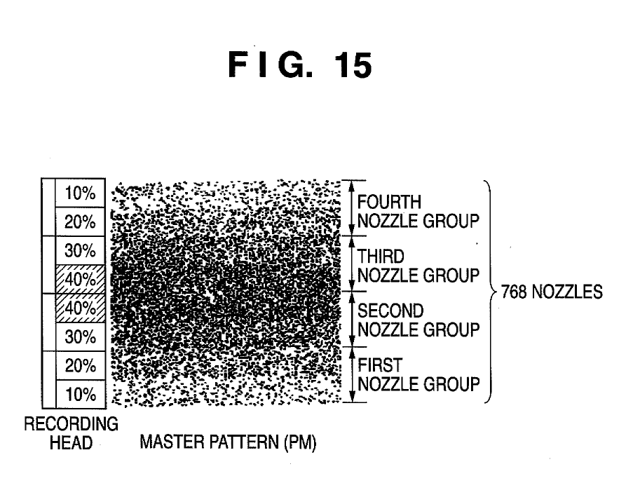

FIG. 14 depicts the recording head configuration. FIG. 15 depicts an example of the mask pattern that is actually applied by the recording head depicted in FIG. 14.

The recording head comprises 768 nozzles for each respective CMYK color. Reference numerals H2000 through H2300 are the recording head arrays that correspond to each respective ink color (hereinafter also referred to as the nozzle array). A recording element substrate H1100 is configured of four nozzle arrays separated by color: a nozzle array H2000 that is supplied with the cyan ink, a nozzle array H2100 that is supplied with the magenta ink, a nozzle array H2200 that is supplied with the yellow ink, and a nozzle array H2300 that is supplied with the black ink. The description in the present example presumes that each nozzle array is configured of 768 nozzles, arranged in the direction of the conveyance of the recording medium, i.e., the sub-scanning direction, at a 1200 dots per inch (dpi) interval.

Consequently, the 768 nozzles are divided into four nozzle groups of 192 nozzles each for the multi-pass recording purposes. The mask pattern is configured to maintain the complementary relationship between the four nozzle groups, with the size of the mask pattern being 768 areas in the vertical direction, the same as the number of nozzles, and 256 areas in the horizontal direction.

In the present circumstance, the data of the mask pattern is stored in the memory that is within the recording apparatus proper. The mask data conversion process applies an AND process between the mask pattern data and the output signal of the dot position patterning process. Doing so determines the recorded pixel that is actually discharged in each respective recording scan. The recorded pixel thus determined is inputted as the output signal to a drive circuit of a recording head H1001.

The recording head of the inkjet recording apparatus that discharges a plurality of small liquid droplets at a high frequency gives rise to an air current in a vicinity of the recording unit during a recording operation. It is known that the air current particularly affects the discharge direction of the nozzle that is located at an edge of the recording head. Consequently, a distribution of a rate of dots, i.e., an aperture rate by region, is given a deviation for each nozzle group or even within a given nozzle group. The configuration minimizes the recording rate of the edge nozzle versus the recording rate of a center portion. Such a configuration allows minimizing a displacement in the impact position of the ink droplet that the edge nozzle discharges.

While the process J0007 and J0008 are described as processed by the recording apparatus, it would be permissible to configure such that the process is performed in whole or in part on the host apparatus.

Control of Ink Discharge Order in Accordance with Color Brightness

Following is a description of a configuration and an operation that is a core of the present invention according to the first embodiment. The configuration of the apparatus per FIGS. 1 and 2 is similar to the configuration of the related art, and thus, a description thereof will be omitted.

Image Data Print Process

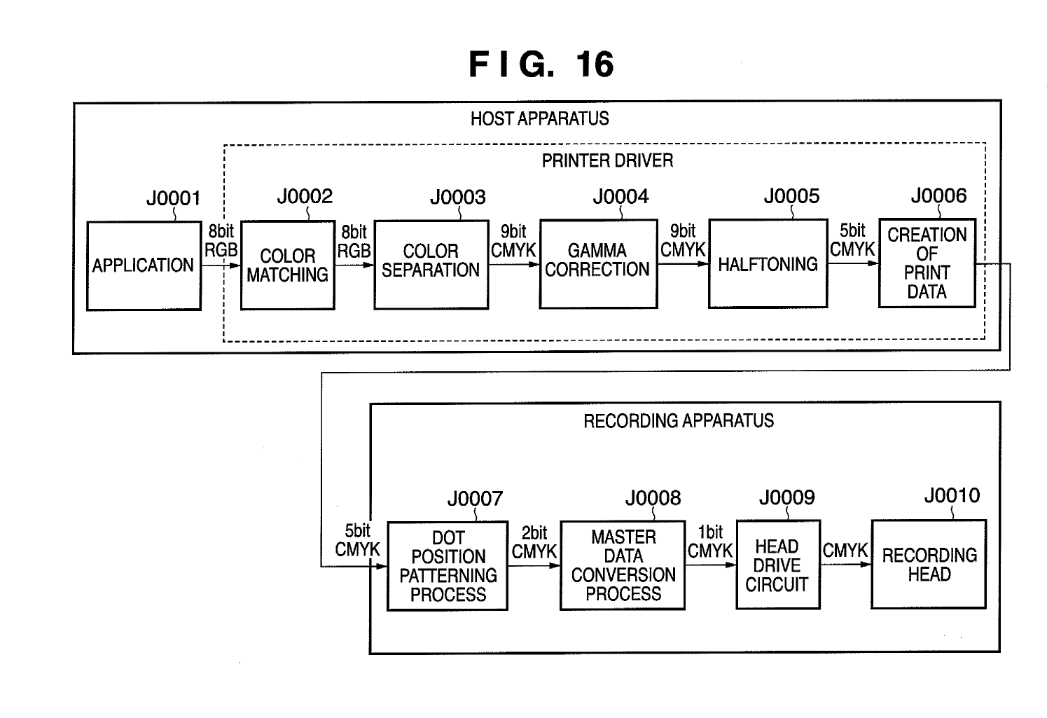

FIG. 16 is a block diagram depicting the data process when printing the image data via the recording apparatus according to the first embodiment. A difference between the depiction in FIG. 16 and the related art in FIG. 3 is that the color separation process J0003 generates the one-bit data that is used in selecting the mask that is prescribed in a process J0008 (to be described hereinafter), in addition to generating the color separation data. Consequently, the image data is outputted by the color separation process J0003 as a nine-bit of each respective color. Eight bits of each color correspond to the color material quantity of C, M, Y, K, while the remaining bit is the value that is used in selecting the mask. Consequently, the image data of each color is compared with FIG. 3 and incremented one bit at a time, during the interval from J0003 to J0008, when the one-bit data is used in the mask data conversion process J0008. The one bit value is employed to perform a control of a recording order for the ink of the color of interest.

Mask Design

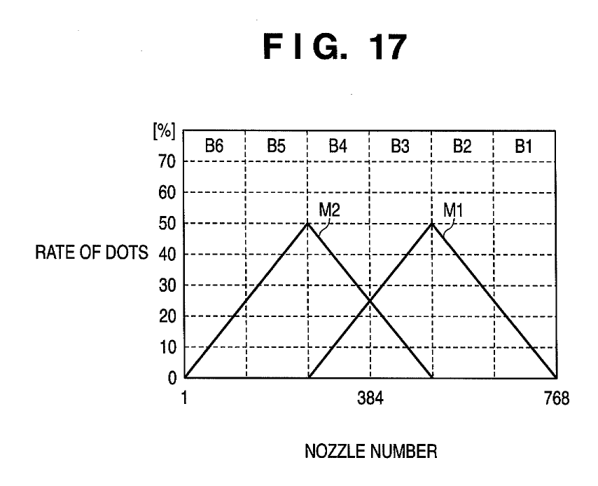

FIG. 17 depicts an exemplary mask design that implements a six-way division of the nozzle array of the recording head, and two segmented multi-pass recordings, for four passes in all. In the present circumstance, an interval between the two mask patterns for the multi-pass recording, M1 and M2, comprises a two-segment interval. Each of the four color inks is recorded using either the M1 or the M2 mask. Consequently, the recording involves six passes for all of the recorded colors, which breaks down as four passes for each color in either the mask M1, i.e., B1 through B4 in the illustration, or the mask M2, i.e., B3 through B6 in the illustration.

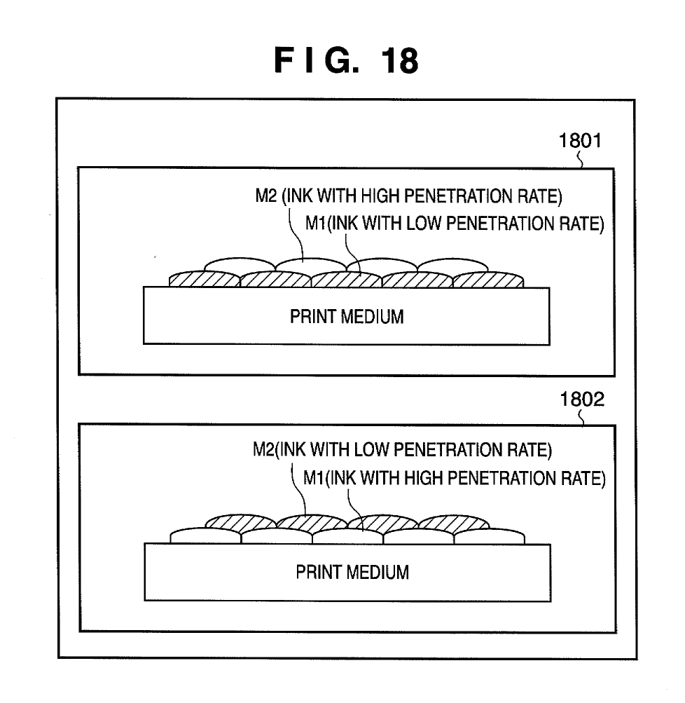

A horizontal axis of the illustration corresponds to the nozzle of the head, employing the preceding 768-nozzle head. The head discharges from nozzle number 768 to nozzle number 1, and thus, a print in a given print region is record processed in units of 128 nozzles from the nozzle number 768. The ink is discharged in descending order of nozzle number. Thus, the ink that is selected by M1 is discharged first, followed by the discharge of the ink that is selected by M2. As a result, the ink that is discharged by M1 is fixed on the recording medium first, such as is depicted in FIG. 18, reference numeral 1801, and the ink that is discharged by M2 is fixed upon the ink layer that is discharged by M1.

It is desirable that the mask pattern pertaining to each respective area B1 through B4 with regard to M1 be identical to the mask pattern pertaining to each respective area B3 through B6 with regard to M2. If the mask patterns are identical, the ink that is discharged by M2 is assured to be fixed upon the ink layer that is discharged by M1, such as is depicted in FIG. 18, reference numeral 1801, without taking such factors as misalignment into account. It is therefore apparent that doing so allows recording an ink of a lesser brightness, i.e., a smaller penetration rate, in M1, and an ink of a greater brightness, i.e., a higher penetration rate, in M2. It is consequently apparent that the color development attribute will not be reduced as a result of absorption of incident light by the ink of the upper layer, which would ordinarily result in the situation depicted in FIG. 18, reference numeral 1802.

Allocation of Respective Recording Colors to the M1 and M2 Masks

### Grouping

Following is a description of a method of determining an order of recording of each respective recording color with in the four-color CMYK configuration. A method of allocating each of the four types of ink to the respective masks M1 M2 will hereinafter be described. The allocation process will hereinafter be referred to as “grouping.”

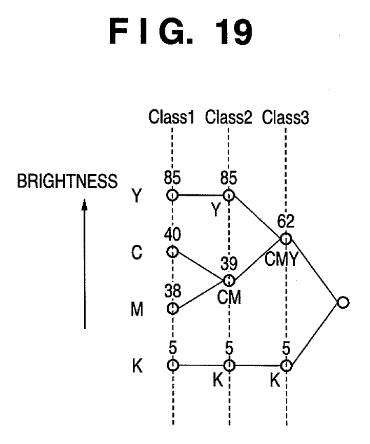

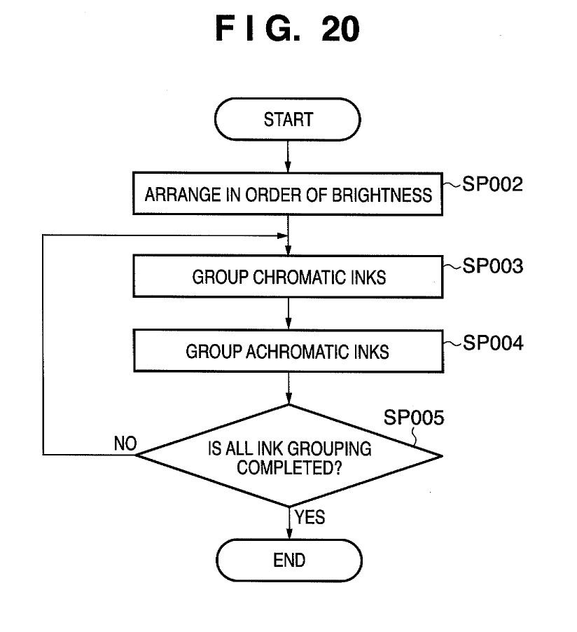

FIG. 19 depicts a typical setting of a grouping with regard to the four-color CMYK ink configuration. FIG. 20 is a grouping process flowchart.

Step SP002 arranges the inks in order by brightness. Specifically, the inks are arranged in descending order by brightness as the Y ink, with brightness 85, the C ink, with brightness 40, the M ink, with brightness 38, and the K ink, with brightness 5, such as is depicted in FIG. 19, Class 1.

A chromatic ink is grouped in step SP003. Specifically, a brightness difference is derived between neighboring inks, a grouping performed starting with the inks with a small brightness difference, and an average brightness of the inks thus grouped is derived, such as is depicted in transitioning from Class 1 to Class 2 in FIG. 19. For example, the inks are arranged into three groups in descending order by brightness as the Y ink, with brightness 85, the C/M ink, with brightness 39, and the K ink, with brightness 5, such as is depicted in FIG. 19, Class 2.

An achromatic ink is grouped in step SP004. If a gray ink is included, such as is described hereinafter according to a first variant embodiment, a grouping is performed for the gray and K inks. The gray ink is not included in the present circumstance, and thus, the step is skipped.

In step SP005, a determination is made as to whether or not all of the ink grouping has been completed. If step SP005 is “NO,” the process repeats steps SP003 and SP004. If step SP005 is “Yes,” i.e. if all of the ink grouping has been completed, the grouping process terminates.

Performing such a process causes the four-color CMYK inks to be grouped into two groups, one group of the C/M/Y inks, and one group of the K ink, such as is depicted in FIG. 19, Class 3.

Mask Allocation

Following is a description of a method of selecting the M1 and M2 masks, in accordance with the grouping process.

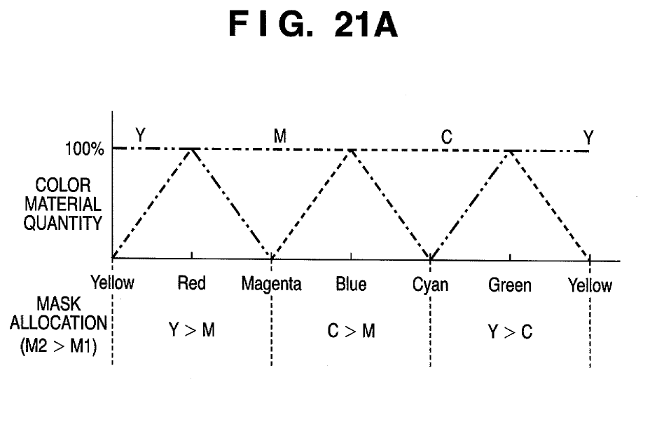

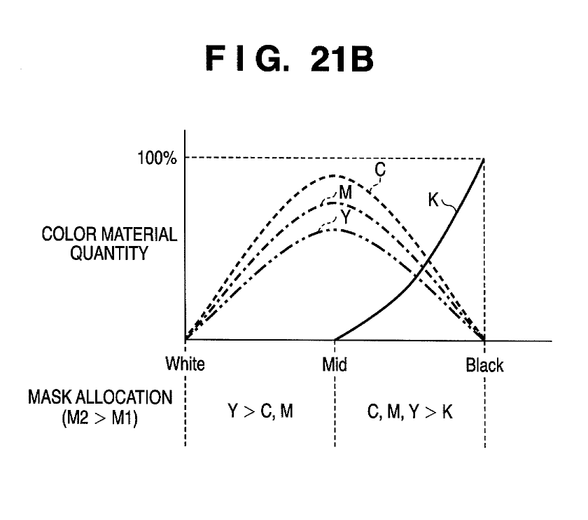

FIG. 21A depicts an exemplary mask allocation in a chromatic region. FIG. 21B depicts an exemplary mask allocation in an achromatic region.

The Y-M hue in FIG. 21A is a mixture of the Y ink and the M ink. In such a circumstance, the mask pattern M2 is selected for the Y ink, which is grouped with the relatively high brightness in FIG. 19, Class 1, and the mask pattern M1 is selected for the M ink, which is grouped with the relatively low brightness therein. Similarly, the mask pattern M2 is selected for the C ink, with the relatively high brightness, and the mask pattern M1 is selected for the M ink, with the relatively low brightness, in the M-C hue. The mask pattern M2 is selected for the Y ink, with the relatively high brightness, and the mask pattern M1 is selected for the C ink, with the relatively low brightness, in the C-Y hue.

An interval between a White and a Mid in FIG. 21B is configured of the three C/M/Y inks, which are thus grouped in FIG. 19, Class 2. The mask pattern M2 is selected for the Y ink, with the relatively high brightness, and the mask pattern M1 is selected for the two C/M inks, with the relatively low brightness. An interval between a Mid and the K is configured of the four C/M/Y/K inks, which are thus grouped in FIG. 19, Class 3. The mask pattern M2 is selected for the three C/M/Y inks, with the relatively high brightness, and the mask pattern M1 is selected for the K ink, with the relatively low brightness.

Thus configured, according to the mixed ink combination, the mask pattern M2 is selected for the ink that is attached to the group with the relatively high brightness, which is thereby recorded relatively later, and the mask pattern M1 is selected for the ink that is attached to the group with the relatively low brightness, which is thereby recorded relatively earlier. With the ink of the add-on variety, such as the pigment ink, the ink that is discharged later is fixed upon the upper layer. Consequently, fixing the ink with the relatively high brightness, i.e., the ink with the high penetration rate, upon the upper layer, allows a higher color development reproduction than when fixing the ink with the relatively low brightness, i.e., the ink with the low penetration rate, upon the upper layer. It is thus possible to implement an expansion of a color reproduction region.

Per the foregoing, it is possible to record, i.e., fix, the ink with the relatively high brightness, i.e., the ink with the high penetration rate, upon the upper layer, i.e., the surface, for the ink with the relatively low brightness, according to the first embodiment. Consequently, it is possible to minimize the reduction of the color development attribute, and to expand the color reproduction region beyond what has been conventionally achieved with regard thereto.

### First Variant Embodiment

The description has been performed with regard to the four-color ink system, according to the first embodiment. It would be permissible, however, to apply the present invention to an ink system with five or more colors. Following is a depiction of a six-color ink example and an eleven-color ink example, which are also used as a product.

In the present circumstance, the six-color ink refers to an addition of a light cyan (Lc) ink and a light magenta (Lm) ink, which have a light pigment density, to the four base C ink, M ink, Y ink, and K ink colors. The eleven-color ink adds the gray (Gy) ink, which has the light pigment density, a light gray (Lg) ink, which has an even lighter pigment density, and a spot color of a Red ink, a Green ink, and a Blue ink.

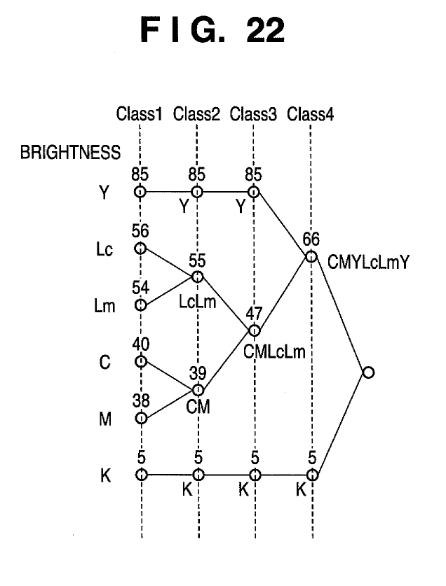

FIG. 22 depicts an exemplary six-color ink grouping. It is possible to employ the flowchart depicted in FIG. 20 according to the first embodiment to derive the six-color ink grouping. All that happens is that the number of chromatic ink groupings increases in step SP003.

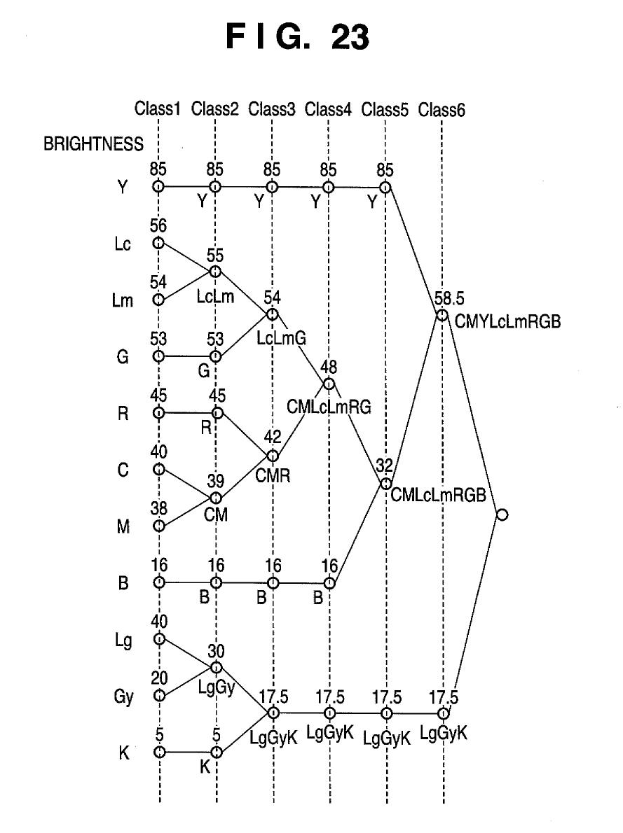

FIG. 23 depicts an exemplary eleven-color ink grouping. It is possible to employ the flowchart depicted in FIG. 20 in similar fashion to the six-color ink grouping to derive the eleven-color ink grouping. All that happens is that the number of chromatic ink groupings increases in step SP003, and the number of achromatic ink groupings increases in step SP004.

It is possible to minimize the reduction of the color development attribute, and to expand the color reproduction region beyond what has been conventionally achieved with regard thereto, by making allocations to the mask M1 and M2, in accordance with the grouping thereof, in similar fashion to the first embodiment.

### Second Variant Embodiment

The description according to the first embodiment employed the two masks M1 and M2, which comprise an inverted “V” distribution of the rate of dots therein. The distribution of the rate of dots is not restricted to the inverted “V,” however. Nor is the number of multi-pass recording passes restricted to four. Nor is the number of positioned masks limited to two.

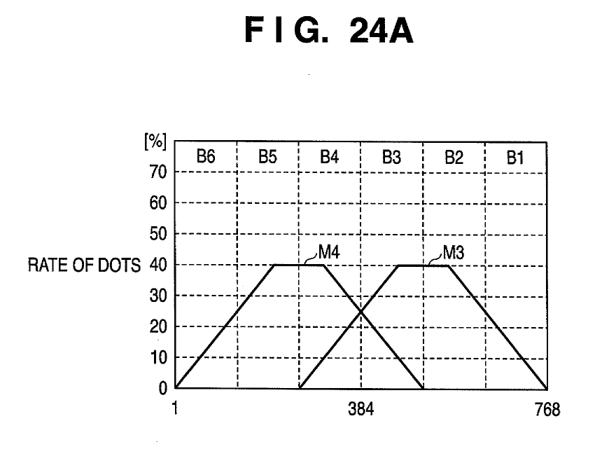

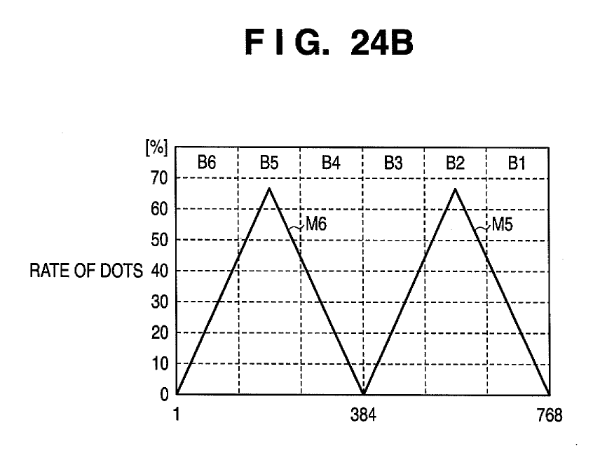

FIG. 24A depicts another example employing the multi-pass system that records a given region in six passes. The system configures two types of masks, of four preceding passes and four succeeding passes, in similar fashion to the first embodiment. The distribution of the rate of dots differs from the distribution thereof that is depicted in FIG. 17, however.

FIG. 24B depicts another example employing the multi-pass system that records a given region in six passes. The system configures two types of masks, however, of three preceding passes and three succeeding passes, unlike the system according to the first embodiment.

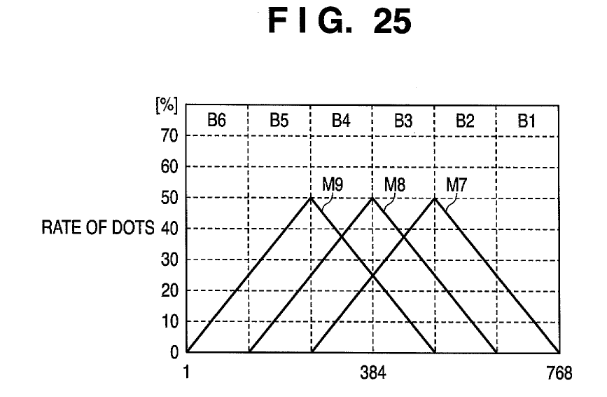

FIG. 25 depicts another example employing the multi-pass system that records a given region in six passes. The system configures three types of masks, however, of four preceding passes, four succeeding passes, and four passes that are further still succeeding, unlike the system according to the first embodiment.

Such a configuration allows finer control over the recording order. When employing the three types of masks, such as is depicted in the present example, the inks are grouped into three groups in the grouping process. For example, the four-color inks would be grouped into three groups, using the Class 2 in FIG. 19. The six-color inks would be grouped into three groups, using the Class 3 in FIG. 22. The eleven-color inks would be grouped into three groups, using the Class 5 in FIG. 23. A two-bit value would be employed to specify the mask allocation in the color separation process J0003.

It would thus be permissible for the number of passes, the shape of the distribution of the rate of dots of the mask, and the number of masks to take any form, provided that the ink system configures the preceding mask and the succeeding mask, at a minimum.

### Other Embodiments

The embodiments of the present invention have hereby been described. It would be permissible, however, to apply the present invention to a system that is configured of a plurality of devices, as well as an apparatus comprised of a single device.

The present invention is achieved by supplying a program that executes the functions of the embodiments, either directly or remotely, to the system or the apparatus, and having the system or the apparatus load and execute the program code thus supplied. Accordingly, the program code that is installed in a computer in order to implement the function processing of the present invention thereupon is itself encompassed within the technological scope of the present invention.

The program may take any form, such as an object code, a program that is executed by an interpreter, or a script that is supplied to an operating system, provided that the function of the program is present.

A recording medium for supplying the program may be such as a floppy disk, a hard drive, an optical disc such as a CD or a DVD, a magneto-optical (MO) disk, a magnetic tape, a nonvolatile memory card, or a ROM.

The functions of the embodiments are implemented by having the computer execute the program thus loaded. It would be permissible for the functions of the embodiments to be implemented by a process that is actually performed by the operating system or other software running on the computer, in accordance with the commands of the program.

The program that is loaded from the recording medium may be written to a memory that is incorporated into an expansion board that is inserted into the computer or an expansion unit that is connected to the computer. The functions of the embodiments are implemented by a process that is actually performed, in whole or in part, by a CPU or other hardware that is incorporated into the expansion board or the expansion unit, in accordance with the commands of the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-353176, filed Dec. 27, 2006, which is hereby incorporated by reference herein in its entirety.

What is claimed is:

1. An image forming apparatus adapted to forming an image by a multi-pass recording, by scan moving a recording medium, in a main scanning direction that is an orthogonal direction to a sub-scanning direction that is a feeding direction of the recording medium, a recording head, comprising a plurality of recording color components of a recording element array that is configured of a plurality of recording elements that are arranged in the sub-scanning direction, and sequentially feeding the recording medium in the sub-scanning direction by a width that is smaller than a width of a band image that may be formed by the recording element array with each successive scan movement of the recording head, the image forming apparatus comprising:
a memory unit adapted to storing n mask patterns, where n is an integer greater than 1, wherein the mask patterns are all different from one another, and are employed in a multi-pass recording that is performed n times;
a recording pattern generation unit adapted to generating n recording patterns, in accordance with the image data of the recording color components and the n mask patterns that are stored in the memory unit;
a classification unit adapted to classifying, into at least two brightness groups, in accordance with a brightness of the recording color components, the n recording patterns of each respective recording color component that are generated by the recording pattern generation unit;
an allocation unit adapted to dividing by m the recording element array of each respective recording color component, where m is an integer greater than n, allocating the n recording patterns of a recording color component that belong to a low-brightness group to n array divisions, of the m array divisions, that are recorded in a preceding order on the recording medium, and allocating the n recording patterns of a recording color component that belong to a high-brightness group to n array divisions, of the m array divisions, that are recorded in a succeeding order on the recording medium; and
a recording control unit adapted to sequentially feeding the recording medium in the sub-scanning direction by a width of 1/m of a width that may possibly be recorded in a single scan motion of the recording array, when recording by scan moving the recording head according to each respective recording pattern of each respective recording color component that is allocated by the allocation unit.

2. The image recording apparatus according to claim 1, wherein:
when an achromatic color recording color component is incorporated in the recording color component, the allocation unit allocates only n recording patterns of the achromatic color recording color component to the n array divisions, of the m array divisions, that are recorded in the preceding order on the recording medium.

3. The image recording apparatus according to claim 1 is an image recording apparatus of an inkjet recording scheme that employs a pigment ink as a color material.

4. A control method of an image forming apparatus adapted to forming an image by a multi-pass recording, by scan moving a recording medium, in a main scanning direction that is an orthogonal direction to a sub-scanning direction that is a feeding direction of the recording medium, a recording head, comprising a plurality of recording color components of a recording element array that is configured of a plurality of recording elements that are arranged in the sub-scanning direction, and sequentially feeding the recording medium in the sub-scanning direction by a width that is smaller than a width of a band image that may be formed by the recording element array with each successive scan movement of the recording head, the control method comprising the steps of:
reading n mask patterns, where n is an integer greater than 1, wherein the mask patterns are all different from one another, and that are employed in a multi-pass recording that is performed n times, from a memory unit adapted to storing the n mask patterns thereof;
generating n recording patterns, in accordance with the image data of the recording color components and the n mask patterns that are stored in the memory unit;
classifying, into at least two brightness groups, in accordance with a brightness of the recording color components, the n recording patterns of each respective recording color component that are generated by the recording pattern generation step;
dividing by m the recording element array of each respective recording color component, where m is an integer greater than n, allocating the n recording patterns of a recording color component that belong to a low-brightness group to n array divisions, of the m array divisions, that are recorded in a preceding order on the recording medium, and allocating the n recording patterns of a recording color component that belong to a high-brightness group to n array divisions, of the m array divisions, that are recorded in a succeeding order on the recording medium; and
sequentially feeding the recording medium in the sub-scanning direction by a width of 1/m of a width that may possibly be recorded in a single scan motion of the recording array, when recording by scan moving the recording head according to each respective recording pattern of each respective recording color component that is allocated in the allocation step.

5. An image forming apparatus adapted to discharging an ink of a plurality of colors, incorporating a pigment as a color material, and performing a plurality of recording scans for a given image region of a recording medium, when forming an image on the recording medium, the image forming apparatus comprising:
an input unit adapted to inputting a plurality of color component data that represents an image to be formed;
a determination unit adapted to determining a combination of an ink that is employed in recording the image to be formed, in accordance with the inputted color component data; and
a processing unit adapted to performing a process for setting a rate of dots of the ink that is employed in the recording, for the color component data, with regard to the plurality of recording scans, in accordance with a result of a determination of the determination unit;
wherein
the processing unit processes the color component data with regard to a final recording scan from among the plurality of recording scans, such that a recording rate of an ink with a relatively high brightness is higher than a recording rate of an ink with a relatively low brightness.

6. A control method of an image forming apparatus adapted to discharging an ink of a plurality of colors, incorporating a pigment as a color material, and performing a plurality of recording scans for a given image region of a recording medium, when forming an image on the recording medium, the method comprising the steps of:
inputting a plurality of color component data that represents an image to be formed;
determining a combination of an ink that is employed in recording the image to be formed, in accordance with the inputted color component data; and
performing a process for setting a rate of dots of the ink that is employed in the recording, for the color component data, with regard to the plurality of recording scans, in accordance with a result of a determination of the determination step;
wherein
the performing step processes the color component data with regard to a final recording scan from among the plurality of recording scans, such that a recording rate of an ink with a relatively high brightness is higher than a recording rate of an ink with a relatively low brightness.

7. A computer-readable recording medium whereupon is recorded a program for causing a computer to execute the control method of the image forming apparatus according to claim 6.
